(19) United States
(12) Patent Application Publication
(10) Pub. No.: US 2016/0077735 A1
(43) Pub. Date: Mar. 17, 2016

(54) CHARACTER INPUT APPARATUS AND CHARACTER INPUT METHOD

(71) Applicant: KABUSHIKI KAISHA TOSHIBA, Tokyo (JP)

(72) Inventor: Noriyo FUJII, Tokyo (JP)

(73) Assignee: KABUSHIKI KAISHA TOSHIBA, Tokyo (JP)

(21) Appl. No.: 14/851,824

(22) Filed: Sep. 11, 2015

Related U.S. Application Data
(60) Provisional application No. 62/051,729, filed on Sep. 17, 2014.

(51) Int. Cl. G06F 3/0488

(52) U.S. Cl. CPC G06F 3/04886

(57) ABSTRACT

A character input apparatus includes a display an input module and an area controller. The display displays characters and a cursor position. The input module has a plurality of keys for instructing deletion of characters displayed on the display. The area controller (i) measures a press time in a case where a key of the input module is pressed, (ii) determines whether the press time is a short time or a long time, (iii) performs an input unique to the key when the press time is a short time, and (vi) instructs a transition to a long press mode to delete characters in a range predetermined with respect to the cursor position when the press time is a long time.

### CROSS-REFERENCE TO RELATED APPLICATION

This application claims priority from U.S. Provisional Patent Application No. 62/051,729 filed on Sep. 17, 2014, the entire contents of which are incorporated herein by reference.

### FIELD

Embodiments of the present invention relate to a character input apparatus and a character input method.

### BACKGROUND

There is a software keyboard technology for displaying a keyboard image on a display device such as an LCD and outputting a key code to a program such as an OS based on an operation input of a user to the corresponding image. Here, as an example of technologies related to software keyboards, it is given a technology for designing a touch type operation keyboard which a user of a computer system uses on a display screen without performing code writing. Also, in general, display is performed when a touch ends.

### BRIEF DESCRIPTION OF THE DRAWINGS

FIG. 1 is a view illustrating a system configuration of a computer according to an embodiment.

FIG. 2 is a view illustrating functional blocks of a key input control program according to the embodiment.

FIG. 3 is a view illustrating an example of a displayable-key list screen which a display unit of the embodiment displays.

FIG. 4 is a state transition diagram of modes of the embodiment.

FIG. 5 is a flow chart illustrating a process in an input mode according to the embodiment.

FIG. 6 is a flow chart illustrating a process in a long press (transition) mode according to the embodiment.

FIG. 7 is a flow chart illustrating a process in a deletion mode according to the embodiment.

FIGS. 8A and 8B are explanatory views illustrating a modification useable in the embodiment.

### DETAILED DESCRIPTION

According to one embodiment, a character input apparatus includes a display, an input module and an area controller. The display displays characters and a cursor position. The input module has a plurality of keys for instructing deletion of characters displayed on the display The area controller (i) measures a press time in a case where a key of the input module is pressed, (ii) determines whether the press time is a short time or a long time, (iii) performs an input unique to the key when the press time is a short time, and (vi) instructs a transition to a long press mode to delete characters in a range predetermined with respect to the cursor position when the press time is a long time.

Various embodiments will be described hereinafter with reference to het accompanying drawings.

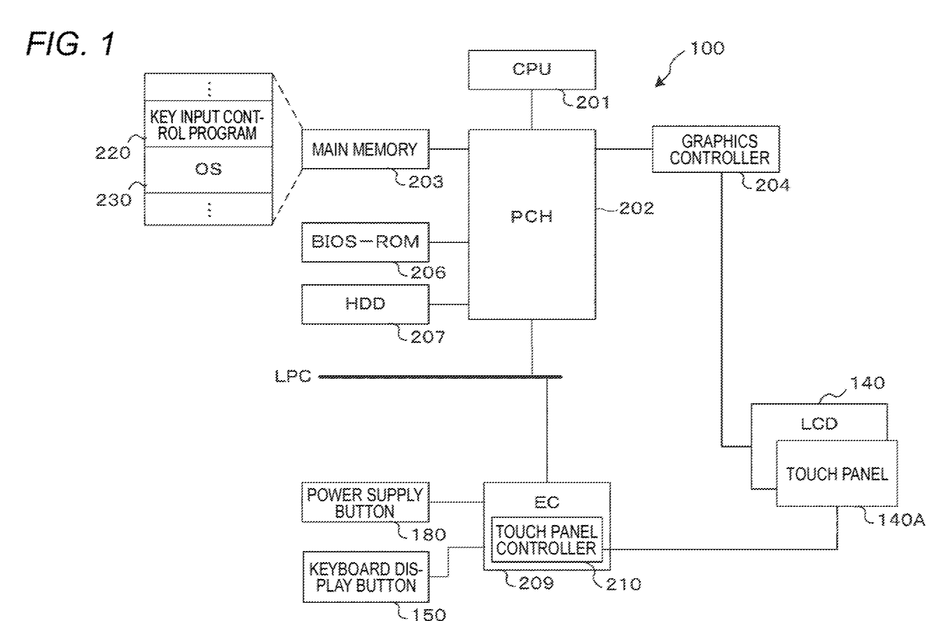

First, with reference to FIG. 1, a system configuration of a computer 100 will be described. FIG. 1 is a view illustrating an overall system configuration in a case of realizing the computer as a tablet PC.

The computer 100 includes a CPU 201, a PCH 202, a main memory 203, a graphics controller 204, a BIOS-ROM 206, a hard disk drive (HDD) 207, a vibration module 208 (not shown in the figure), an embedded controller 209, and so on.

The CPU 201 is a processor provided for controlling operations of the computer 100, and executes an operating system (OS) 230, various application programs such as a key input control program 220, and the like which are loaded from the HDD 207 into the main memory 203.

Also, the CPU 201 has a function of executing a system BIOS (Basic Input Output System) which is a program stored in the BIOS-ROM 206 in order to control hardware of the computer 100.

The PCH 202 is a device connecting a local bus of the CPU 201 and each component. The PCH 202 includes a memory controller for controlling access to the main memory 203. The PCH 202 also includes a serial ATA controller and an integrated drive electronics (IDE) controller for controlling the HDD 207.

The main memory 203 is a temporal storage area into which the OS and various applications to be executed by the CPU 201 are loaded. Into the main memory 203, programs such as the OS 230 and the key input control program 220 stored in the HDD 207 are loaded.

The graphics controller 204 is a display controller for controlling an LCD 140 which is used as a display of the computer 100. Based on a drawing request which is received from the CPU 201 through the PCH 202, the graphics controller 204 performs a display process (a graphics computing process) for performing drawing based on display data in a video memory (VRAM). The video memory includes a storage area for storing display data corresponding to screen images to be displayed on the LCD 140.

The embedded controller (EC) (/keyboard controller (KBC)) 209 has a function of powering on or off the computer 100 in response to an operation of the user on a power supply button 180. Also, the embedded controller (EC) 209 includes a touch panel controller 210 which controls a touch panel 140A provided on the LCD 140.

Also, the touch panel 140A is configured so as to detect a touch area (a touch position) on the touch panel (a touch screen display), for example, by a resistive film system or an electrostatic capacitance system. Drivers for the touch panel 140A and other components will be separately mentioned.

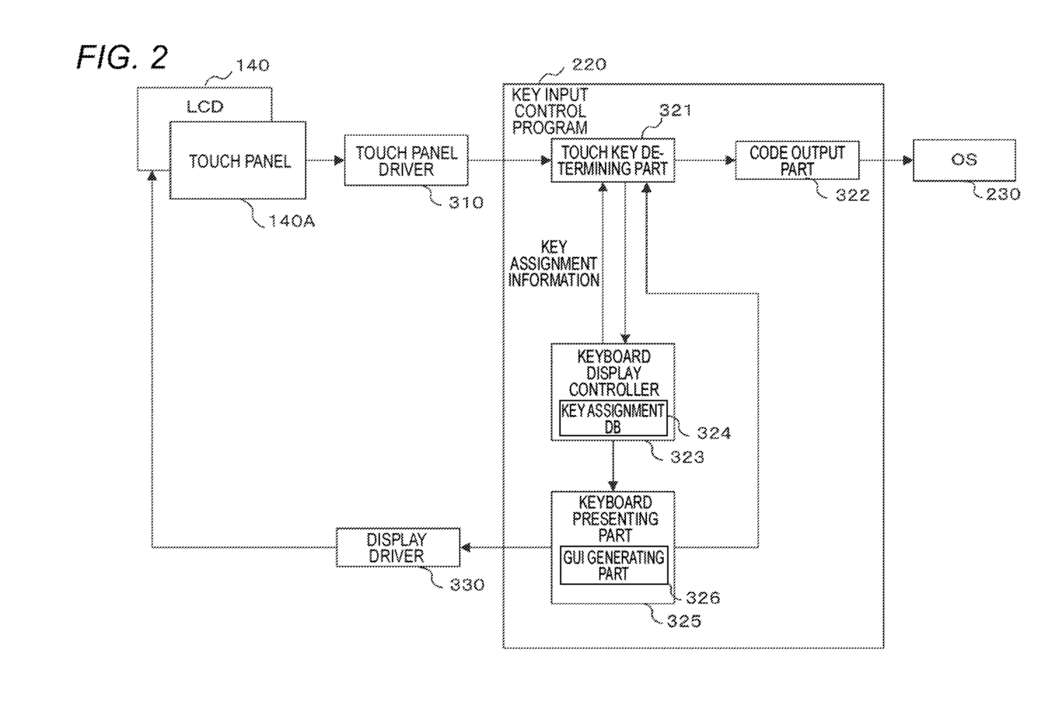

Now, with reference to FIG. 2, functional blocks of the key input control program 220 will be described.

The key input control program 220 includes a touch key determining part 321, a code output part 322, a keyboard display controller 323, and a keyboard presenting part 325.

In a case where the touch panel 140A receives a touch operation input and detects a touch area having received the corresponding operation input, the touch key determining part 321 inputs touch area detection information from a touch panel driver 310. The touch area detection information includes coordinate data representing the touch area (touch position) of the touch panel 140A touched by an external member (such as a user's finger or a pen).

Next, based on the corresponding touch area detection information, window information Which is input from the keyboard presenting part 325, and key assignment information which is input from the keyboard display controller 323, the touch key determining part 321 determines which key has been touched by the user.

That is, the touch key determining part 321 acquires the touch area detection information on the coordinate information of the area of the touch panel 140A having received the touch operation, and acquires the window information which is coordinate information on the position, size, and the like of a keyboard window to be displayed on the LCD 140, and the key assignment information which is coordinate information representing which key is assigned to which area of the corresponding window. Then, the touch key determining part 321 compares the coordinate information of the touch area detection information with the coordinate information of the window information and the key assignment information, thereby determining which key has received the operation input.

Here, in a case of determining that a key other than a display switching key of the keys of the software keyboard has received the touch operation, the touch key determining part 321 outputs a notification related to the key having received the corresponding touch operation input to the code output part 322 while notifying the keyboard display controller 323 of the key having received the corresponding touch operation input.

Meanwhile, in a case of determining that the display switching key of the software keyboard has received the operation input, the touch key determining part 321 notifies the keyboard display controller 323 of the display switching key having received the corresponding operation input.

If the notification of the key having received the touch operation input is received from the touch key determining part 321, the code output part 322 outputs a code corresponding to the operated key to the OS 230.

In a case where the notification of the display switching key having received the operation input is received from the touch key determining part 321, the keyboard display controller 323 outputs the key assignment information based on the corresponding notification to the touch key determining part 321 while instructing the keyboard presenting part 325 to perform keyboard image display switching. Also, in the case where the notification of the key haying received the touch operation input is received from the touch key determining part 321, the keyboard display controller 323 instructs the keyboard presenting part 325 to change the image display form of the key having received the operation input.

Also, the keyboard display controller 323 includes a key assignment database 324. Here, the key assignment database 324 is a database related to the key assignment information which represents where which key is disposed in the keyboard window to be displayed on the LCD 140, by coordinate data or the like. Also, the key assignment information may represent the position of each key by coordinate values calculated using the lower left or upper left of the keyboard window as a reference point, and the corresponding coordinate values may relatively vary in response to the position of the keyboard window. Also, in a case where the size of the keyboard window changes, the corresponding coordinate values may be changed according to the size.

The keyboard presenting part 325 controls the LCD 140 through a display driver 330 such that the LCD displays the software keyboard. Also, the keyboard presenting part 325 includes a GUI generating part 326. In a case where an instruction for switching keyboard image display is received from the keyboard display controller 323, the GUI generating part 326 generates a keyboard image based on the corresponding instruction. Meanwhile, in a case where an instruction for changing the display form of the key having received the operation input is received, the GUI generating part 326 changes the display form of the image of the corresponding key, thereby generating a keyboard image. Then, the keyboard presenting part 325 outputs a keyboard window including the generated keyboard image to the display driver 330, whereby the LCD 140 displays a keyboard.

Also, while outputting the keyboard window to the display driver 330, the keyboard presenting part 325 outputs the window information on the position, size, and the like of the keyboard window on the LCD 140 to the touch key determining part 321. Also, in some cases such as a case where the display position of the keyboard window changes, the keyboard presenting part 325 outputs corresponding window information.

In a case where the display driver 330 receives an input of the keyboard window from the keyboard presenting part 325, it controls the LCD 140 such that the LCD displays the corresponding keyboard window.

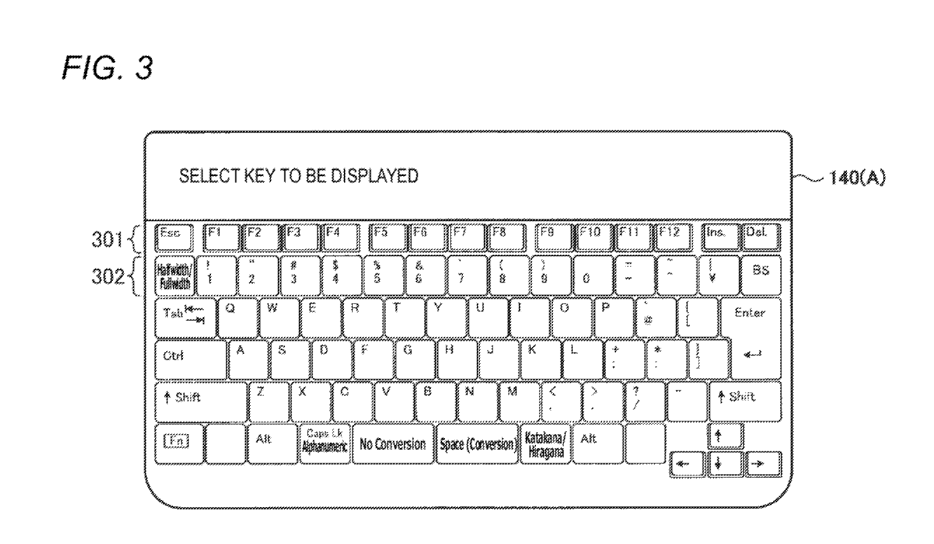

Subsequently, with reference to FIG. 3, the keyboard which the computer 100 of the present embodiment displays will be described. FIG. 3 is a view illustrating an example of the display mode of a keyboard window (an example of the software keyboard) which the computer 100 displays.

In the example shown in FIG. 3, the keyboard has a line (a row) 301 where function keys are arranged, and a line (a row) 302 where numeric keys are arranged. As so-called delete (cancel) keys, a “Del.” (delete) key and a “BS” (back space) key are disposed at the right end of the line 301 and the right end of the line 302, respectively. In this key layout such as a so-called QWERTY layout, in general, at a home position where the user puts hands, the left index finger and the right index finger are put on the “F” key and the “J” key, respectively.

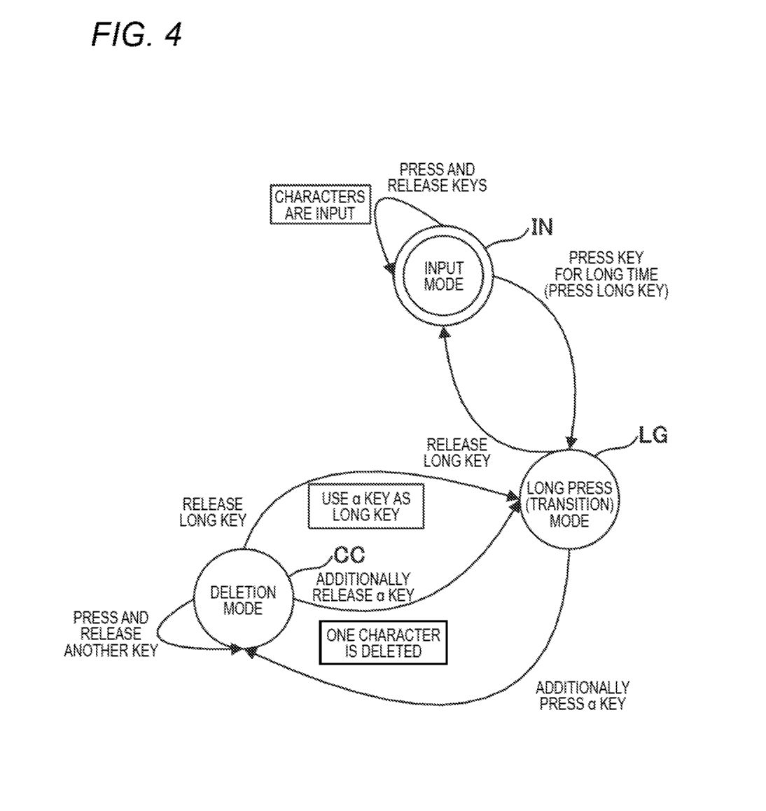

FIG. 4 is a state transition diagram of modes of the embodiment. The key input control program 220 has a normal character input state as an input mode IN. In a case where the user inputs wrong characters, if the user keeps pressing an arbitrary key (referred to as a long key) for a predetermined time, the key input control program 220 transitions to a transition mode LG, and then if the user presses another arbitrary key (referred to as an α key), the key input control program 220 transitions to a deletion mode CC.

In this case, by releasing the second α key, it is possible to delete one character. Further, if the user wants to keep deleting characters, the user can delete an arbitrary number of characters by pressing and releasing the α key the same number of times as the number of characters which the user wants to delete while keeping the state of the long key as it is. As long as pressing of the arbitrary key selected as the long key is kept for the predetermined time or more, the key input control program 220 can transition to the deletion mode CC.

In a case of releasing the long key earlier in the deletion mode CC, the key input control program 220 transitions to the transition mode LG in which it becomes possible to use the key as the long key keep, whereby it is possible to proceed with deleting by repeatedly operating another key.

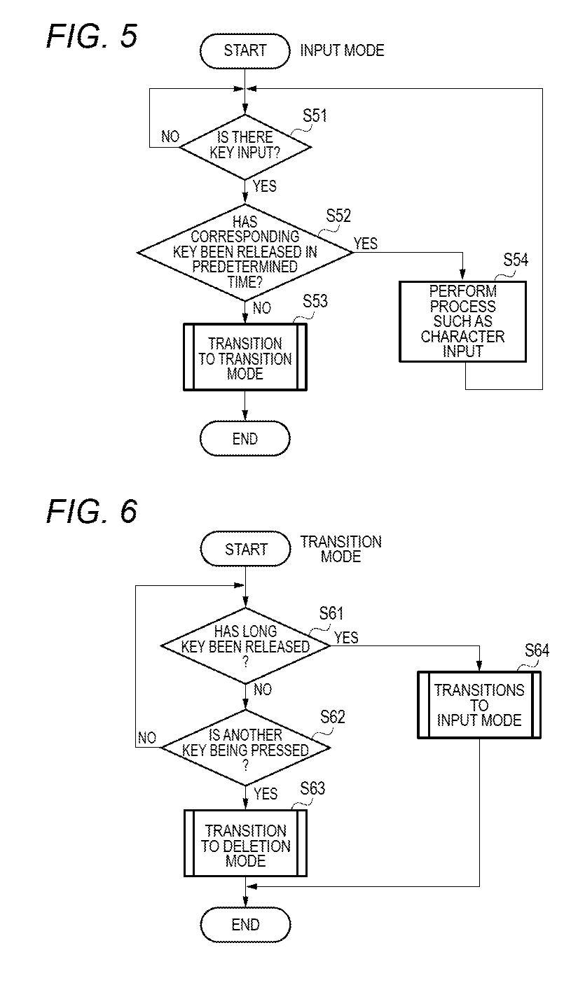

FIG. 5 shows user's key operations, mode switching, and processes in the input mode IN. In a system in which it is possible to operate a specific key like a “Shift” key, it is determined whether an operated key is the specific key, and a unique process according to each input is performed.

The key input control program 220 idles until there is a key input. If it is determined in STEP S51 that there is a key input, the key input control program 220 proceeds to STEP S52.

If it is determined in STEP S52 that the corresponding key has been released in a predetermined time (for example, 0.5 sec), the key input control program 220 proceeds to STEP S54. Otherwise, the key input control program 220 proceeds to STEP S53.

In STEP S53, the key input control program 220 determines the corresponding key as the long key, and transitions to the transition mode. Then, the key input control program 220 finishes the flow.

In STEP S54, the key input control program 220 performs a normal process, such as character input, according to the corresponding key.

FIG. 6 shows key operations and mode switching in the transition mode LG. Even after the key input control program transitions to the transition mode, if the user releases the long key the key input control program switches to the input mode.

If it is determined in STEP S61 that the long key has been released, the key input control program 220 proceeds to STEP S64.

If it is determined in STEP S62 that an arbitrary key other than the long key is being pressed, the key input control program 220 determines the corresponding arbitrary key as the α key, and proceeds to STEP S63. Otherwise, the key input control program 220 returns to STEP S61.

In STEP S63, the key input control program 220 transitions to the deletion mode. Then, the key input control program finishes the flow.

In STEP S64, the key input control program 220 transitions to the input mode. Then, the key input control program finishes the flow.

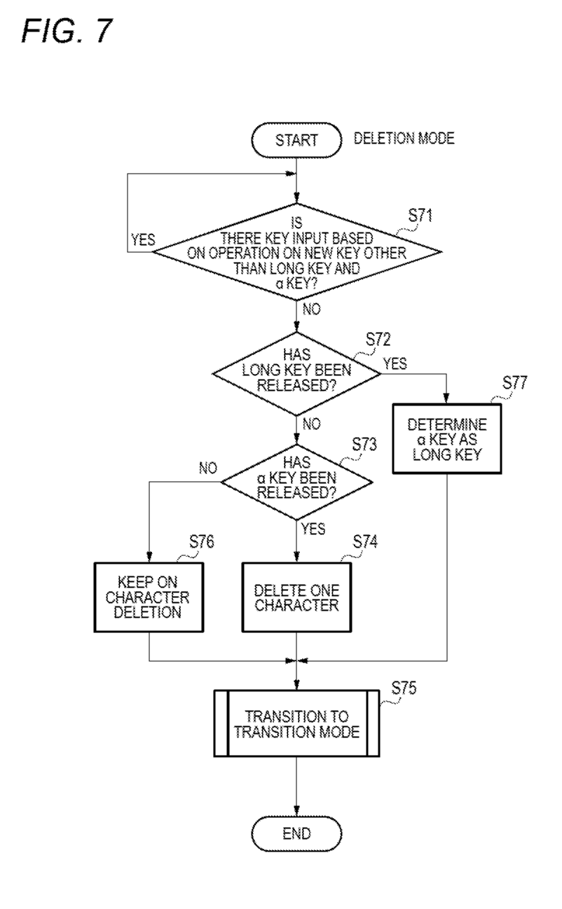

FIG. 7 shows key operations, mode switching, and processes in the deletion mode CC. The key input control program 220 can change the number of deletion times according to the number of taps on a key (the α key) having resulted in a transition to the deletion mode.

Also, in a case of releasing the long key while keeping on pressing the α key, the key input control program 220 switches the α key to a new key, and transitions to the transition mode. Also, in a case where both of the two keys are being pressed, even if any other key is touched, the key input control program 220 ignores that key input.

In STEP S71, it is determined whether there is a key input based on an operation on a new key other than the long key and the α key. In a case where the result of the determination of STEP S71 is “Yes”, the key input control program 220 ignores the corresponding key input and keeps on idling. Otherwise, the key input control program 220 determines that any one of the long key and the α key has been released or the predetermined time (for example, 0.5 sec) has elapsed, and proceeds to STEP S72.

In a case of determining in STEP S72 that the long key has been released, the key input control program 220 proceeds to STEP S77.

In STEP S73, it is determined whether the a key has been released. In a case where the result of the determination of STEP S73 is “Yes”, the key input control program 220 proceeds to STEP S74. Otherwise, the key input control program 220 determines that the predetermined time has elapsed, and proceeds to STEP S76.

In STEP S74, the key input control program 220 deletes one character located at the position of a cursor. Then, the key input control program proceeds to STEP S75.

In STEP S75, the key input control program 220 transitions to the transition mode. Then, the key input control program finishes the flow.

In STEP S76, the key input control program 220 keeps on gradually deleting characters from the position of the cursor. If the a key is released (or if a deletion target word finishes), the key input control program 220 proceeds to STEP S75.

In STEP S77, the key input control program 220 determines the a key as a new long key. Then, the key input control program 220 proceeds to STEP S75.

In STEP S76, by pressing the second key for a long time it is possible to keep on character deletion. As another modification, it is possible to enable the user to designate a portion to be deleted by flicking the second key.

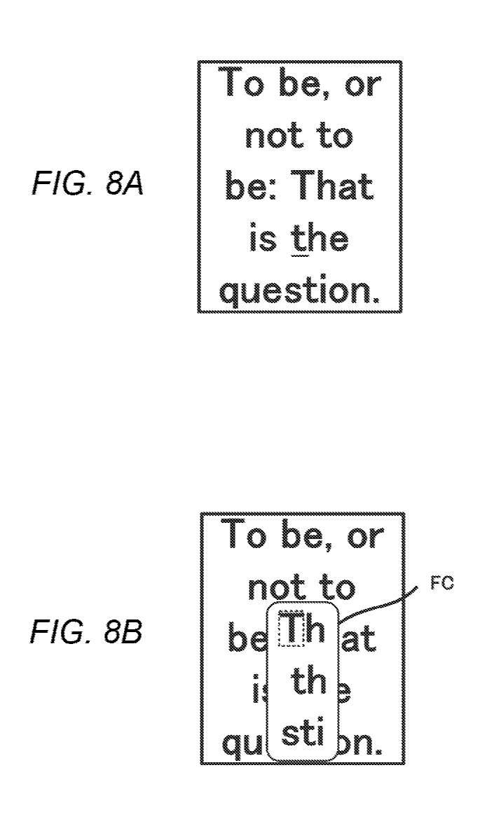

FIGS. 8A and 8B show an example in which a sentence “To be, or not to be: that is the question” has been input on a small screen of, for example, a mobile phone. Since the first character of “that” has been input with a capital as shown in FIG. 8A, it is a task to delete that character and input a correct character.

Since a cursor is at the position of “t” of “the”, according to methods of the related art, it is apt to be necessary to move the cursor to a target position via the left end of the corresponding row and the right end of the previous row in an environment in which there is no mouse. It is preferable to configure a character input apparatus such that in the deletion mode CC, a character focus area fc surrounding the character “t” in all directions is shown in FIG. 8B, and modify STEP S74 described above such that if the a key is flicked, for example, upward, the target “T” is deleted. Thereafter, the cursor may remain for a predetermined time, and if “t” is input, after a while, the cursor may automatically return to the position of “t” of “the”.

Also, as another modification, there is a system in which input characters are displayed on the screen immediately after keys of a hardware keyboard or the like are pressed. In this case, if the system is configured such that a character disappears by long press, a mode transition may become known to the user. It is also necessary to configure the system such that it is valid to simultaneously press two keys other than modifier keys.

Until now, there has been a problem in which deletion operations cause erroneous inputs, erroneous operations, or a decrease in character input efficiency. It has been usual to press an application button adjacent to a key group on a small screen, resulting in recovery.

However, according to the above described embodiment in which a delete key of a software keyboard or the like is assigned, due to assignment of a new key other than a unique delete key, the user is less likely to move fingers from the home position. Therefore, it is possible to reduce typing errors, and it is possible to efficiently perform character deletion. Also, it is possible to reduce erroneous operations according to delete key operations, and user's stress decreases. Further, since it becomes less likely to consecutively touch the delete key position, it is possible to extend the life of the panel.

In order to solve the problem, in the present embodiment, it has been devised to perform deletion by simultaneously operating two keys (the first key is pressed for a long time and the second key is pressed and released the same number of times as the number of deletion target characters). According to this device, deletion is performed by a combination of keys other than the delete key.

Other features include a feature in which switching among three modes of the input mode, the transition mode, and the deletion mode is performed, a feature in which the number of characters to be deleted is determined by the number of second-key operations, and a feature in which characters around the position of the cursor are deleted by flicking the second character to the left, right, up, and down (even diagonally if possible).

Also, the present invention is not limited to the above described embodiment, and can be variously modified without departing from the scope thereof. For example, it may be possible to enable the user to set the length of each temporal element if desired.

Also, the plurality of constituent elements disclosed in the above described embodiment can be combined appropriately, whereby it is possible to form various inventions. For example, from all constituent elements shown in the embodiment, several constituent elements may be eliminated. Furthermore, constituent elements according to any other embodiments may be appropriately combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A character input apparatus comprising:
a display that displays characters and a cursor position;
an input module that has a plurality of keys for instructing deletion of characters displayed on the display; and
an area controller (i) that measures a press time in a case where a key of the input module is pressed, (ii) that determines Whether the press time is a short time or a long time, (iii) that performs an input unique to the key when the press time is a short time, and (vi) that instructs a transition to a long press mode to delete characters in a range predetermined with respect to the cursor position when the press time is a long time.

2. The character input apparatus according to claim 1, wherein:
in a case where another key of the input module is additionally pressed in the long press mode, a press time of the corresponding key is measured, and
when this press time is a short time, the characters in the range are deleted one by one.

3. The character input apparatus according to claim 1, wherein:
in a case where another key of the input module is additionally pressed in the long press mode, a press time of the corresponding key is measured, and
when this press time is a long time, the characters in the range are deleted continuously.

4. The character input apparatus according to claim 3, wherein:
the characters in the range are continuously deleted until a deletion target word ends.

5. The character input apparatus according to claim 2, wherein:
characters selected from the characters in the range based on a flicking operation of a user are deleted.

6. A character input method comprising:
displaying characters and a cursor position;
inputting at least one of a plurality of keys for instructing deletion of displayed characters; and
measuring a press time in a case where one of the plurality of keys is pressed;
determining whether the press time is a short time or a long time;
performing an input unique to the key when the press time is a short time; and
instructing a transition to a long press mode to delete characters in a range predetermined with respect to the cursor position when the press time is a long time.
